(19) United States
(12) Patent Application Publication
(10) Pub. No.: US 2008/0304270 A1
(43) Pub. Date: Dec. 11, 2008

(54) LIGHT EMITTING DIODE HEAT DISSIPATION MODULE

(75) Inventors: Ching Ho, Taipei (TW); Yu-Chu Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AMA PRECISION INC., Taipei (TW)

(21) Appl. No.: 12/128,633

(22) Filed: May 29, 2008

(30) Foreign Application Priority Data
Jun. 6, 2007 (TW) 96120321

(51) Int. Cl. F21V 29/00

(52) U.S. Cl. 362/373

(57) ABSTRACT

A light emitting diode (LED) heat dissipation module is suitable to dissipate heat for at least a LED. The LED heat dissipation module includes a heat dissipation base, at least a heat conductor, and a plurality of heat dissipation fins. The heat dissipation base has a first surface and a second surface corresponding to the first surface. The LED is provided on the first surface and the heat conductor is provided on the second surface. In addition, the heat dissipation fins are provided at the heat conductor, and the heat dissipation fins are separated from the heat dissipation base.

### CROSS-REFERENCE TO RELATED APPLICATION

This application claims the priority benefit of Taiwan application serial no. 96120321, filed on Jun. 6, 2007. The entirety of the above-mentioned patent application is hereby incorporated by reference herein and made a part of this specification.

### BACKGROUND OF THE INVENTION

1. Field of the Invention

The invention relates to a heat dissipation module and, more particularly, to a light emitting diode (LED) heat dissipation module.

2. Description of the Related Art

In recent years, since a light emitting diode (LED) has advantages of a small dimension and a long service life, the LED has been broadly applied in various electronic products or illuminating apparatuses. For example, light sources for projecting and displaying in liquid crystal displays or backlight modules of projectors on the market mostly are LEDs currently. However, the LED generates plenty of heat energy when it works, the conventional technology makes a fin heat radiator provided on the LED of the backlight module to dissipate the heat for the LED.

FIG. 1 is a schematic diagram showing a conventional fin heat radiator provided at a light emitting diode (LED). Please refer to FIG. 1, a fin heat radiator 100 includes a heat dissipation base 110 having a first surface 110a and a second surface 110b, and a fin assembly 120. Wherein the fin assembly 120 is arranged on the second surface 110b of the heat dissipation base 110, and a LED 10 is suitable to be provided on the central area of the first surface 110a.

At present, since electronic products such as liquid crystal displays or projectors on the market are developed to be light and thin, the interior of the liquid crystal displays or the projectors has limited heat dissipation space, and the fin heat radiator 100 with a large dimension cannot be provided in the liquid crystal displays or the projectors which have limited heat dissipation space for the heat dissipation of the LED 10. However, the LED 10 dispose at the central area of the first surface 110a of the heat dissipation base 110, when the heat generated by the LED 10 conducts to the heat dissipation base 110, the heat only be effectively conducted to the fin assembly 122 which is located at the central area of the heat dissipation base 110 and cannot be conducted to the fin assembly 124 which is located at the periphery of the heat dissipation base 110 easily, which causes the heat dissipation efficiency of the fin heat radiator 100 for dissipating the heat for the LED 10 is bad. Therefore, how to dispose the LED heat dissipation module in the limited heat dissipation space of the electronic products, and increase the heat dissipation efficiency of the LED heat dissipation module at the same time is an important subject.

### BRIEF SUMMARY OF THE INVENTION

The invention provides a light emitting diode (LED) heat dissipation module suitable for an electronic product with limited interior space, and the LED heat dissipation module can effectively dissipate the heat from a LED in the electronic product.

The invention provides a LED heat dissipation module which is suitable to dissipate the heat from at least a LED. The LED heat dissipation module includes a heat dissipation base, at least a heat conductor and a plurality of heat dissipation fins. Wherein the heat dissipation base has a first surface and a second surface corresponding to the first surface. The LED is provided on the first surface, and the heat conductor is provided on the second surface. The heat dissipation fins are provided at the heat conductor, and the heat dissipation fins are separated from the heat dissipation base.

In one embodiment of the invention, the LED position corresponds to the heat conductor position.

In one embodiment of the invention, the LED heat dissipation module farther includes a heat conduction plate, and the LED is provided at the heat conduction plate provided at the first surface of the heat dissipation base.

In one embodiment of the invention, the heat conduction plate is an aluminum plate or a copper plate.

In one embodiment of the invention, the heat conductor is preferred to be integrally formed with the heat dissipation base.

In one embodiment of the invention, the heat conductor is preferred to be a pillar.

In one embodiment of the invention, the heat conductor is preferred to be an inverted T pillar which includes a first connecting portion extending from the heat dissipation base and two second connecting portions extending from the first connecting portion, and the heat dissipation fins are assembled at the second connecting portions.

In the LED heat dissipation module of the invention, a heat conductor is preferred to be provided at the second surface of the heat dissipation base, and a plurality of heat dissipation fins are provided through the heat conductor. In the invention, the shape of the heat conductor, the position of the heat dissipation fins in the heat conductor and the dimension of the heat dissipation fins depend on the heat dissipation space. In other words, the LED heat dissipation module of the invention is suitable for limited interior heat dissipation space of the electronic product. In addition, the heat conductor of the invention can effectively conduct the heat energy generated by the LED to each fin, and therefore, the LED heat dissipation module of the invention can effectively dissipate the heat form the LED in the electronic product.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a schematic diagram showing a conventional fin heat radiator provided at a light emitting diode (LED).

FIG. 2 is a schematic diagram showing a LED heat dissipation module in an embodiment of the invention.

FIG. 3 is a schematic diagram showing a LED heat dissipation module in another embodiment of the invention.

FIG. 4 is a schematic diagram showing a LED heat dissipation module in another embodiment of the invention.

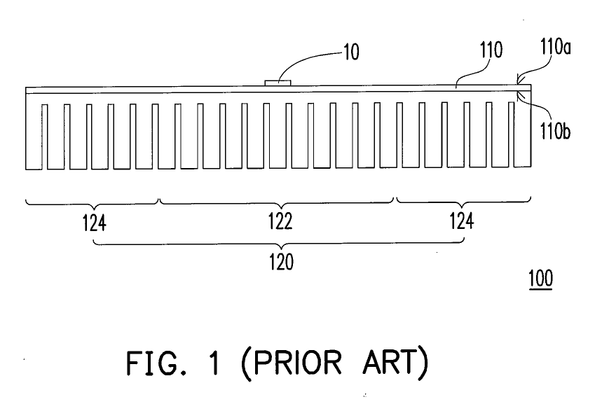

### DETAILED DESCRIPTION OF THE EMBODIMENTS

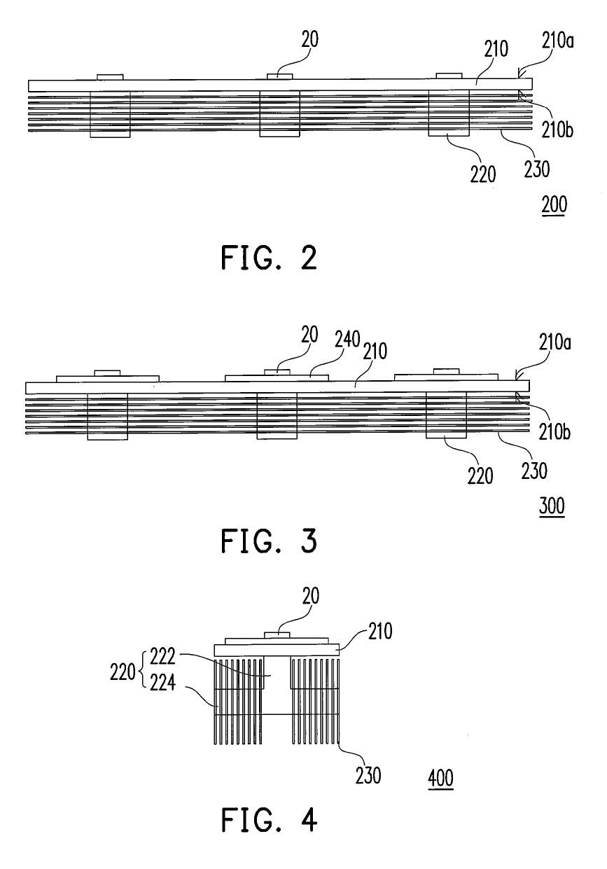

FIG. 2 is a schematic diagram showing a light emitting diode (LED) heat dissipation module in an embodiment of the invention. Please refer to FIG. 2, a LED heat dissipation module 200 of the embodiment is suitable to dissipate the heat form at least one LED 20 (three LEDs 20 are shown in FIG. 2). In the embodiment, the LED heat dissipation module 200 includes a heat dissipation base 210, at least a heat conductor 220 (three heat conductors 220 are shown in FIG. 2) and a plurality of heat dissipation fins 230. The heat dissipation base 210 has a first surface 210a and a second surface 210b corresponding to the first surface 210a.

Please go on referring to FIG. 2. In the embodiment, the LED 20 is suitable to be provided on the first surface 210a, and the heat conductor 220 is provided on the second surface 210b and is integrally formed with the heat dissipation base 210. The material of the heat dissipation base 210 can be, for example, copper or aluminum that with better heat conductive efficiency. In addition, the heat dissipation fins 230 are preferably provided on the heat conductor 220, and forms separated without contact to the heat dissipation base 210. Specifically, the heat conductor 220 in the embodiment can be, for example, a pillar, and the heat dissipation fins 230 can have, for example, a through hole, and therefore, the heat dissipation fins 230 can be provided through the heat conductor 220 by the through hole. In addition, the position where the heat conductor 220 provided is preferred to be corresponding to the position where the LED 20 disposed, and therefore, the heat generated by the LED 20 can be directly and effectively conducted to the heat conductor 220 via the heat dissipation base 210 and is convected to the environment via the heat dissipation fins 230 provided on the heat dissipation base 210.

In the embodiment, the heat dissipation base 210 and the heat conductor 220 formed thereon can be provided according to the dimension of the interior heat dissipation space of the electronic product, and the heat dissipation fins 230 can tightly fit with the heat conductor 220 by interfering, tin soldering or thermosetting adhesive. Similarly, the configure of the heat dissipation fins 230 depends on the dimension of the heat dissipation space, hence, the interior heat dissipation space of the electronic product can be fully and effectively utilized. In this way, the heat dissipation module 200 can be successfully provided into the electronic product with limited heat dissipation space. In addition, since the position where the heat conductor 220 is provided in the embodiment is corresponding to, for example, the position where the LED 20 is provided, the heat energy generated by the LED 20 can further be diffused and be conducted to each heat dissipation fin 230 after the heat energy is conducted to the heat conductor 220, which increases the heat dissipation area, improves the heat dissipation efficiency, and makes the LED heat dissipation module 200 effectively dissipate the heat for the LED 20 in the electronic product.

FIG. 3 is a schematic diagram showing a LED heat dissipation module in another embodiment of the invention. A LED heat dissipation module 300 of the embodiment is similar to the LED heat dissipation module 200 of the above embodiment, and the main difference between them is that the LED heat dissipation module 300 of the embodiment further includes a heat conduction plate 240, and the LED 20 contacts with the heat conduction plate 240 which is provided on the first surface 210a of the heat dissipation base 210. In the embodiment, the heat conduction plate 240 can be, for example, an aluminum plate or a copper plate. Wherein the heat conduction plate 240 contacts with the heat dissipation base 210 with a large contact area, and therefore, the heat energy generated by the LED 20 can be further effectively conducted to the heat dissipation base 210 and can be convected to the environment via the heat dissipation fins 230 which tightly fit with the heat conductor 220. In other words, the LED heat dissipation module 300 in the embodiment can further effectively dissipate the heat for the LED 20.

FIG. 4 is a schematic diagram showing a LED heat dissipation module in another embodiment of the invention. Please refer to FIG. 4. In a LED heat dissipation module 400 of the embodiment, a heat conductor 220 can be designed to be, for example, an inverted T pillar according to the heat dissipation space of the electronic product, and the heat conductor 220 includes a first connecting portion 222 extending from the heat dissipation base 210 and two second connecting portions 224 extending from the first connecting portion 222 (for example, the two second connecting portions 224 are connected to two sides of the first connecting portion 222, respectively.), and the heat dissipation fins 230 can be assembled to the second connecting portions 224. Compared with the LED heat dissipation modules 200 and 300 in the first embodiment and the second embodiment, the LED heat dissipation module 400 in the embodiment can also effectively dissipate the heat for the LED 20.

Although the heat conductor 220 is, for example, a pillar or an inverted T pillar in the above embodiment, the heat conductor 220 can also be other appropriate shapes in other embodiments, and it is not limited in the invention.

To sum up, in the invention, to enable the LED heat dissipation module to be provided into the electronic product with limited heat dissipation space, the heat dissipation base and the heat conductor provided on the heat dissipation base are designed according to the size of the heat dissipation space, and the heat dissipation fins provided on the heat conductor are also designed according to the size of the heat dissipation space, so that the LED heat dissipation module is suitable to be provided in the light and thin electronic product with limited heat dissipation space to dissipate the heat for the LED in the electronic product.

Furthermore, in the LED heat dissipation module of the invention, since the position where the heat conductor is provided is corresponding to the position where the LED is provided, after the heat energy generated by the LED is conducted to the heat dissipation base, it can be effectively conducted to each heat dissipation fin via the heat conductor, and then the heat energy generated by the LED is convected to the environment via the heat dissipation fins. In addition, since the position where the heat dissipation fins is provided at the heat conductor and the size of the heat dissipation area of the heat dissipation fins can be designed according to the size of the heat dissipation space, the LED heat dissipation module of the invention can effectively utilize the heat dissipation space in the electronic product to improve the heat dissipation efficiency of the LED heat dissipation module. In other words, the LED heat dissipation module of the invention can further effectively dissipate the heat for the LED in the electronic product.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A light emitting diode (LED) heat dissipation module which is suitable to dissipate heat from at least a LED, the LED heat dissipation module comprising:
a heat dissipation base having a first surface and a second surface which is corresponding to the first surface, wherein the LED is provided on the first surface;
at least a heat conductor provided on the second surface; and
a plurality of heat dissipation fins provided at the heat conductor, wherein the heat dissipation fins are separated from the heat dissipation base.

2. The LED heat dissipation module according to claim 1, wherein the heat conductor position is corresponding to the LED position.

3. The LED heat dissipation module according to claim 1 further comprising a heat conduction plate, wherein the LED is provided at the heat conduction plate, and the heat conduction plate is provided at the first surface of the heat dissipation base.

4. The LED heat dissipation module according to claim 3, wherein the heat conduction plate is an aluminum plate or a copper plate.

5. The LED heat dissipation module according to claim 1, wherein the heat conductor and the heat dissipation base is integrally formed.

6. The LED heat dissipation module according to claim 1, wherein the heat conductor is a pillar.

7. The LED heat dissipation module according to claim 1, wherein the heat conductor is an inverted T pillar.

8. The LED heat dissipation module according to claim 7, wherein the inverted T pillar comprises a first connecting portion extending from the heat dissipation base, and two second connecting portions extending from the first connecting portion, where the heat dissipation fins are formed at the second connecting portions.
